(19) United States
(12) Patent Application Publication
(10) Pub. No.: US 2005/0031951 A1
(43) Pub. Date: Feb. 10, 2005

(54) Alkaline dry battery

(76) Inventors: Takashi Mushiga, Osaka (JP); Kenji Yamamoto, Osaka (JP)

Correspondence Address: MCDERMOTT WILL & EMERY LLP, 600 13th Street, N.W., Washington, DC, 20005-3096, US

(21) Appl. No.: 10/909,844

(22) Filed: Aug. 3, 2004

(30) Foreign Application Priority Data
Aug. 6, 2003 (JP) JP2003-287747

(51) Int. Cl. H01M 2/08; H01M 10/04

(52) U.S. Cl. 429/184; 429/185; 29/623.2

(57) ABSTRACT

In an alkaline dry battery according to the present invention, a film comprising epoxy adduct polyamide amine having an amine value in the range of 150 to 500 is arranged between a negative electrode current collector and a gasket. Since the epoxy adduct polyamide amine is water-soluble, there is no need to dissolve the epoxy adduct polyamide amine in an organic solvent to form the film comprising the epoxy adduct polyamide amine. Further, the resulting epoxy adduct polyamide amine film is highly resistant to electrolyte leakage.

### BACKGROUND OF THE INVENTION

The present invention relates to an alkaline dry battery. In particular, it relates to an alkaline dry battery having an improved sealant film between a negative electrode current collector and a gasket.

In alkaline dry batteries, a sealant film has conventionally been provided between a negative electrode current collector and a gasket for the purpose of preventing an electrolyte from leaking. The sealant is required to have stability against the electrolyte and action of preventing the electrolyte from creeping due to capillary action. As such a sealant, there have been used those capable of being dissolved only in an organic solvent, e.g., a mixed organic solvent containing alcohol such as isopropanol and toluene.

More specifically, epoxy adduct polyamide amine having an amine value of about 95 has been used as such a sealant. The epoxy adduct polyamide amine is a polymer of an epoxy resin and diamine. The epoxy adduct polyamide amine cannot be dissolved in anything but an organic solvent if its amine value is 100 or lower.

On the other hand, epoxy adduct polyamide amine having an amine value of 50 to 200 is used as a sealant for a button-shaped alkaline battery (see Japanese Laid-Open Patent Publication No. SHO58-19854). In this case, the sealant is arranged between a negative electrode sealing plate and a gasket.

For example, in the process of manufacturing an alkaline dry battery, a solution prepared by dissolving a sealant in an organic solvent is applied to a current collector and the organic solvent is evaporated off to form a sealant film on the current collector. On the other hand, it has been known that such an organic solvent is an environmental pollutant. Accordingly, in view of growing environmental awareness in recent years, various measures have been taken such as reduction of VOC (volatile organic compounds). Collection of spent VOC has also been put into practice, but at present, it has not been achieved to a sufficient degree. For this reason, the application of the sealant to the current collector has to be carried out without dissolving the sealant in the organic solvent, for example, by applying a heat-fused sealant or an aqueous solution prepared by dissolving a water-soluble sealant in water to the current collector.

However, in order to fuse the sealant to apply it directly, a huge amount of heat energy is required. On the other hand, there has not been found a water-soluble sealant having both stability against an electrolyte and action of preventing the electrolyte from creeping due to capillary action.

Under these circumstances, the present invention intends to provide an alkaline dry battery including a water-soluble sealant, which has both stability against an electrolyte and action of preventing the electrolyte from creeping due to capillary action and arranged between a negative electrode current collector and a gasket.

### BRIEF SUMMARY OF THE INVENTION

In order to solve the above-mentioned problems, the inventors of the present invention have made a study of an amine value of epoxy adduct polyamide amine to use a water-soluble epoxy adduct polyamide amine as a sealant.

That is, the present invention relates to an alkaline dry battery comprising:
(a) a metallic case containing a power generating element therein; and
(b) a sealing plate assembly for sealing an opening of the metallic case.

The sealing plate assembly comprises a negative electrode terminal, a negative electrode current collector electrically connected with the negative electrode terminal, and a gasket having a through hole into which the negative electrode current collector is inserted. Further, a film comprising epoxy adduct polyamide amine having an amine value in the range of 150 to 500 is arranged between the negative electrode current collector and the gasket.

Regarding the above-described alkaline dry battery, the film comprising the epoxy adduct polyamide amine is preferably formed by applying an aqueous solution of epoxy adduct polyamide amine to part of the negative electrode current collector to be in contact with the gasket and evaporating water therefrom.

Further, the present invention relates to a method of manufacturing the above-described alkaline dry battery comprising the steps of:
(1) applying an aqueous solution prepared by dissolving the above-described epoxy adduct polyamide amine in water to part of the negative electrode current collector to be in contact with the gasket; and
(2) evaporating water therefrom to form a film comprising the epoxy adduct polyamide amine.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a vertical sectional view illustrating an embodiment of an alkaline dry battery according to the present invention.

### DETAILED DESCRIPTION OF THE INVENTION

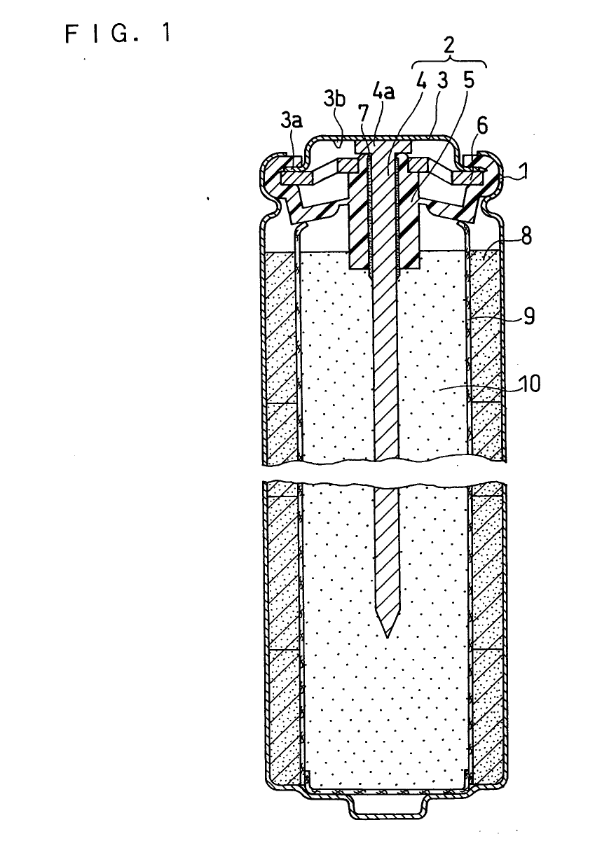

FIG. 1 shows an alkaline dry battery according to an embodiment of the present invention.

The alkaline dry battery shown in FIG. 1 comprises a metallic case 1 serving as a positive electrode terminal, a power generating element contained in the metallic case 1 and a sealing plate assembly 2 for sealing an opening of the metallic case 1.

The sealing plate assembly 2 comprises a disc-shaped negative electrode terminal 3 having a brim portion 3a on the periphery thereof, a nail-shaped negative electrode current collector 4 electrically connected with an inner bottom surface 3b of the negative electrode terminal 3 at a flat head 4a, and a gasket 5 having a through hole into which the negative electrode current collector 4 is inserted. The gasket 5 is provided with a groove on the periphery thereof, into which a metallic support 6 is engaged. Further, a sealant film 7 is arranged between the negative electrode current collector 4 and the gasket 5. The sealant film 7 comprises epoxy adduct polyamide amine having an amine value in the range of 150 to 500 (hereinafter may be referred to as a sealant).

The power generating element comprises a hollow cylindrical positive electrode material mixture 8 arranged in contact with the inner wall of the metallic case 1, a cylindrical separator 9 having a bottom arranged in contact with the inner wall of the positive electrode material mixture 8, a gel negative electrode 10 filled inside the separator 9 and an alkaline electrolyte (not shown).

The negative electrode current collector 4 may be made of brass, for example.

The gasket 5 may be made of a polypropylene resin, for example.

The metallic case 1, the negative electrode terminal 3 and the metallic support 6 may be made of any material known in the art, respectively.

The positive electrode material mixture 8, the separator 9 and the gel negative electrode 10 serving as the power generating element contained in the metallic case 1 may also be made of any material known in the art, respectively.

Then, an explanation is given of the epoxy adduct polyamide amine used to form the sealant film.

The epoxy adduct polyamide amine used in the present invention has an amine value of 150 to 500. The epoxy adduct polyamide amine of this kind is hard to be dissolved in an alkaline electrolyte. Accordingly, a sealant film comprising the epoxy adduct polyamide amine becomes highly resistant to electrolyte leakage.

Having the amine value of 150 to 500, the epoxy adduct polyamide amine exhibits water solubility. That is, if the amine value is not lower than 150, more preferably not lower than 210, the epoxy adduct polyamide amine can be dissolved in water. However, if the amine value is lower than 150, the epoxy adduct polyamide amine cannot be easily dissolved in water.

If the amine value exceeds 500, the resulting sealant film is apt to retain water therein, decreasing its viscosity. Accordingly, the sealant film tends to come off easily.

It is more preferable that the amine value of the epoxy adduct polyamide amine is in the range of 150 to 250 because the amine value in this range makes the epoxy adduct polyamide amine less prone to being dissolved in the alkaline electrolyte and further improves the resistance to electrolyte leakage.

The sealant film comprising the epoxy adduct polyamide amine preferably has a thickness ranging from 20 to 60 μm.

The above-described epoxy adduct polyamide amine may be made of an epoxy resin and diamine. Examples of the epoxy adduct polyamide amine include those represented by the following structural formula: 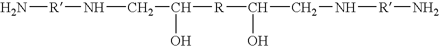
(R, R′: hydrocarbon chain)

The epoxy resin to be added to diamine may be, for example, bisphenol A epoxy resin.

In the above formula, R and R′ are preferably a hydrocarbon chain having a hydrocarbon group such as an ethylene group, a group comprising an ether skeleton or the like.

When the epoxy adduct polyamide amine is made of an epoxy resin and diamine, the mixing ratio of the epoxy resin to diamine is preferably 100:10-60 by weight.

Next, an explanation is given of an example of a method of forming the sealant film comprising the epoxy adduct polyamide amine.

As described above, the epoxy adduct polyamide amine having an amine value in the range of 150 to 500 is water-soluble. Accordingly, an aqueous solution of the sealant may be used to form the sealant film. For example, the sealant film may be formed on the negative electrode current collector by the steps of:
(1) applying an aqueous solution prepared by dissolving the epoxy adduct polyamide amine in water to part of the negative electrode current collector to be in contact with the gasket; and
(2) evaporating water therefrom to form a film comprising the epoxy adduct polyamide amine.

In this manner, there is no need to dissolve the sealant into an organic solvent, thereby reducing emission of VOC.

In the above step (2), evaporation of water is preferably carried out at a temperature of 60° C. to 80° C. for at least about 20 minutes.

In the present invention, the amine value of the epoxy adduct polyamide amine means a total amount of a primary amino group, a secondary amino group and a tertiary amino group contained in the epoxy adduct polyamide amine. The amine value is represented by the number of mg of an equivalent weight of potassium hydroxide equal to an equivalent weight of hydrochloric acid required for neutralizing 1 g of the epoxy adduct polyamide amine.

More specifically, the amine value is determined in the following manner:
(1) the epoxy adduct polyamide amine is weighed to be 0.5 to 2 g and this weight is regarded as Sg;
(2) the weighed epoxy adduct polyamide amine is dissolved in 30 ml of neutral ethanol;
(3) the resulting ethanol solution is subjected to titration using 0.2 mol/l of ethanol-hydrochloric acid solution (factor: f) and the titer is regarded as Aml.

With these values, the amine value is calculated by the following formula:
Amine value=(A×f×0.2×56.108)/S

The value 56.108 is a molecular weight of potassium hydroxide.

Hereinafter, the present invention is described in detail by way of examples.

### EXAMPLE 1

(1) Evaluation of the Susceptibility of the Sealant Film to Peeling

A visual check was carried out with respect to the susceptibility of the sealant film to peeling in the insertion process of the negative electrode current collector into the gasket.
(i) Fabrication of Sealing Plate Assembly

A sealing plate assembly 2 shown in FIG. 1 was fabricated.

First, a flat head 4a of a negative electrode current collector 4 was welded to an inner bottom surface 3b of a negative electrode terminal 3.

Epoxy adduct polyamide amines each having the amine values shown in Table 1 were dissolved in water such that the concentration of the epoxy adduct polyamide amine became 30 wt %, respectively. Each of the obtained aqueous solutions was applied to part of the negative electrode current collector 4 to be in contact with the gasket 5 and dried at 80° C. for 25 minutes to form a sealant film 7 on the negative electrode current collector 4. In this manner, 20 negative electrode current collectors each provided with the sealant film 7 were formed for each of the amine values indicated in Table 1.

Since the epoxy adduct polyamide amine having an amine value of 95 is not dissolved in water, it was dissolved in an organic solvent comprising 21 parts by weight of xylene, 9 parts by weight of butanol, 20 parts by weight of toluene and 20 parts by weight of isopropyl alcohol. At that time, the concentration of the epoxy adduct polyamide amine was controlled to be 30 wt %.

The resulting organic solution was applied to the negative electrode current collector and the organic solvent mixture was evaporated therefrom by heating at 60° C. for 15 minutes to obtain a sealant film.

Thus, 20 negative electrode current collectors each having the sealant film were formed.

Then, a metallic support 6 was engaged in a groove of the gasket 5 and the negative electrode current collector 4 with the sealant film 7 formed thereon was inserted into a through hole of the gasket 5, thereby completing the sealing plate assembly. Table 1 shows, with respect to each of the amine values, the number of the sealing plate assemblies which caused peeling of the sealant film 7 off the negative electrode current collector 4 during the insertion, as well as the number of the sealing plate assemblies in which the negative electrode current collector protruded from the gasket (i.e., the flat head of the negative electrode current collector detached from the gasket) in a day after the fabrication.

TABLE 1

| | The number of sealing | The number of sealing plate |
|---|---|---|
| | plate assemblies which | assemblies in which the |
| | caused peeling of the | current collector protruded |
| Amine | sealant film off the | in a day after the |
| value | current collector | fabrication |
| 95 | 0/20 | 2/20 |
| 150 | 0/20 | 0/20 |
| 200 | 0/20 | 0/20 |
| 300 | 0/20 | 0/20 |
| 500 | 0/20 | 0/20 |
| 600 | 4/20 | 0/20 |
| 700 | 5/20 | 0/20 |
| 800 | 13/20 | 0/20 |

As understood from Table 1, when the amine value was smaller than 150, the negative electrode current collector protruded due to elastic force of the sealant film, making the fabrication of the battery difficult. On the other hand, with the amine value larger than 500, the sealant film was apt to peel off in the fabrication of the sealing plate assembly. Accordingly, the amine value of the epoxy adduct polyamide amine used as the sealant is required to be in the range from not lower than 150 to not higher than 500.

### EXAMPLE 2

(2) Evaluation of Resistance to Electrolyte Leakage

With the epoxy adduct polyamide amine having an amine value in the range of 150 to 500 used as the sealant, electrolyte leakage from the alkaline dry battery was visually checked.
(i) Assembling of battery

An alkaline dry battery shown in FIG. 1 was fabricated.

In a metallic case 1 serving as a positive electrode terminal, a hollow cylindrical positive electrode material mixture 8 was placed, which was molded using a pressing jig to be in close contact with an inner wall of the metallic case 1. A cylindrical separator 9 having a bottom was arranged to be in contact with the positive electrode material mixture 8 and a predetermined amount of an alkaline electrolyte was injected inside the separator 9. Then, a gel negative electrode 10 was filled inside the separator 9.

Subsequently, a sealing plate assembly 2 was fabricated in the same manner as Example 1 above. Then, the negative electrode current collector 4 of the sealing plate assembly 2 was inserted into the center of the gel negative electrode 10 and an opening of the metallic case 1 was sealed with the negative electrode terminal 3. In the final step, the opening end of the metallic case 1 was crimped via the gasket 5 onto a brim portion 3a on the periphery of the negative electrode terminal 3 contacting the metallic support 6, thereby sealing the metallic case 1. Thus, an alkaline dry battery was completed. Alkaline dry batteries each adopting the sealants having the amine values shown in Table 2 were referred to as batteries A, B, C and D, respectively. For each of the amine values, 20 alkaline dry batteries were prepared and stored at 60° C. and 90% RH to count the number of batteries that caused leakage. Table 2 shows the results.

As a comparison, a battery was fabricated using a sealant made of epoxy adduct polyamide amine having an amine value of 95.

First, a sealant film was formed on the negative electrode current collector in the same manner as Example 1.

Then, a sealing plate assembly was fabricated and an alkaline dry battery was completed in the same manner as the above. The thus obtained alkaline dry battery was referred to as a comparative battery 1. In the same manner as the above, 20 comparative batteries 1 were prepared and stored to count the number of batteries that caused the leakage. The results are also shown in Table 2.

TABLE 2

| | Storage period | | |
|---|---|---|---|
| | 1 month | 3 months | 5 months |
| Comparative battery 1 | 0/20 | 0/20 | 4/20 |
| (amine value: 95) | | | |
| Battery A | 0/20 | 0/20 | 1/20 |
| (amine value: 150) | | | |
| Battery B | 0/20 | 0/20 | 1/20 |
| (amine value: 200) | | | |
| Battery C | 0/20 | 0/20 | 3/20 |
| (amine value: 300) | | | |
| Battery D | 0/20 | 0/20 | 3/20 |
| (amine value: 500) | | | |

(Leaked battery/stored battery)

As understood from Table 2, the number of the leaked batteries among the batteries A to D was smaller than those among the comparative batteries 1 even after the 5-month storage period.

As described above, the present invention allows applying an aqueous solution prepared by dissolving epoxy adduct polyamide amine having an amine value ranging from 150 to 500 in water to a current collector. Accordingly, there is no need to use an organic solvent to dilute the epoxy adduct polyamide amine as done in a conventional technique. Further, with use of the above-described sealant, the present invention provides an alkaline dry battery which is less prone to leak the electrolyte.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. An alkaline dry battery comprising:
(a) a metallic case containing a power generating element therein; and
(b) a sealing plate assembly for sealing an opening of said metallic case, wherein
said sealing plate assembly comprises a negative electrode terminal, a negative electrode current collector electrically connected with said negative electrode terminal, and a gasket having a through hole into which said negative electrode current collector is inserted, and
a film comprising epoxy adduct polyamide amine having an amine value in the range of 150 to 500 is arranged between said negative electrode current collector and said gasket.

2. The alkaline dry battery in accordance with claim 1, wherein said film comprising epoxy adduct polyamide amine is formed by applying an aqueous solution of said epoxy adduct polyamide amine to part of said negative electrode current collector to be in contact with said gasket and evaporating water therefrom.

3. A method for manufacturing the alkaline dry battery in accordance with claim 1, comprising the steps of:
(1) applying an aqueous solution prepared by dissolving epoxy adduct polyamide amine having an amine value of 150 to 500 in water to part of a negative electrode current collector to be in contact with a gasket; and
(2) evaporating water therefrom to form a film comprising said epoxy adduct polyamide amine.
